(19) United States
(12) Patent Application Publication
(10) Pub. No.: US 2024/0070690 A1
(43) Pub. Date: Feb. 29, 2024

(54) METHOD AND SYSTEM FOR FORECASTING AGRICULTURAL PRODUCT PRICE BASED ON SIGNAL DECOMPOSITION AND DEEP LEARNING

(71) Applicant: Xi'an University of Architecture and Technology, Xi'an (CN)

(72) Inventors: Xinsheng ZHANG, Xi'an (CN); Runzhou WANG, Xi'an (CN); Chang YANG, Xi'an (CN); Yiwei HAN, Xi'an (CN); Chunyang WU, Xi'an (CN); Yanan LI, Xi'an (CN)

(21) Appl. No.: 17/971,917

(22) Filed: Oct. 24, 2022

(30) Foreign Application Priority Data
Aug. 23, 2022 (CN) 202211010832.2

(51) Int. Cl. G06Q 30/02

(52) U.S. Cl. CPC G06Q 30/0202; G06Q 50/02

(57) ABSTRACT

Disclosed are a method and a system for forecasting an agricultural product price based on signal decomposition and deep learning. The method includes: S1, obtaining price subsequences by performing a complementary ensemble empirical mode decomposition (CEEMD) on an original price sequence of agricultural products; S2, obtaining a reconstructed sequence based on the price subsequences; S3, obtaining data features of the reconstructed sequence based on the reconstructed sequence; and S4, constructing a Bi-directional Sequence to Sequence (BiSeq2seq) model, and inputting the data features of the reconstructed sequence into a CCS-Bi-directional Sequence to Sequence (CCS-BiSeq2seq) model to obtain a forecasting result.

### CROSS-REFERENCE TO RELATED APPLICATIONS

This application claims priority to Chinese Patent Application No. 202211010832.2, filed on Aug.23, 2022, the contents of which are hereby incorporated by reference.

### TECHNICAL FIELD

The application relates to the technical field of agricultural product price forecasting, and in particular to a method and a system for forecasting an agricultural product price based on signal decomposition and deep learning.

### BACKGROUND

China is a big agricultural country, and a fluctuation of agricultural product prices affects people's livelihood and stable development of national economy. With a spread of African plague in 2019, a promulgation of a new national environmental protection breeding policy and an outbreak of COVID-19 epidemic in 2020, abnormal price fluctuations of the agricultural products have gradually increased. The abnormal price fluctuations of the agricultural products seriously affect people's life stability and the stable development of national economy. Therefore, an establishment of an accurate agricultural product price forecasting model to prevent an impact of unexpected events on people's lives plays an important role in solving problems of agriculture, rural areas and farmers and agricultural informatization construction.

At present, researches on the agricultural product price forecasting are mainly divided into three kinds of forecasting methods: conventional econometric methods, artificial intelligence methods and combination models, and all kinds of methods are developed in chronological order. The above research enriches the conventional price forecasting research, and make the conventional econometric methods gradually form a systematic time sequence forecasting model. However, the conventional econometric methods have strong limitations in dealing with nonlinear problems.

### SUMMARY

To solve problems existing in the prior art, the application provides a method and a system for forecasting an agricultural product price based on signal decomposition and deep learning. The method adopts a complementary set empirical mode decomposition method, combines Pearson correlation coefficients for a sequence reconstruction, and then extracts time sequence relationships between data by a one-dimensional convolutional neural network (CNN) convolution, and then introduces a self-attention mechanism and strengthens a global correlation; and finally, the method constructs a Bi-directional Sequence to Sequence (BiSeq2seq) network for a multi-step forecasting, thus greatly improving a forecast accuracy.

On the one hand, in order to achieve the above technical objectives, the application provides a method for forecasting an agricultural product price based on signal decomposition and deep learning, including:

S1, obtaining price subsequences by performing a complementary ensemble empirical mode decomposition (CEEMD) on an original price sequence of agricultural products;

S2, obtaining a reconstructed sequence based on the price subsequences;

S3, obtaining data features of the reconstructed sequence based on the reconstructed sequence; and

S4, constructing a Bi-directional Sequence to Sequence (BiSeq2seq) model, and inputting the data features of the reconstructed sequence into a CCS-Bi-directional Sequence to Sequence (CCS-BiSeq2seq) model to obtain a forecasting result.

Optionally, the S2 includes:

analyzing the Pearson correlation coefficients and the price subsequences, and reconstructing to obtain the reconstructed sequence, where the reconstructed sequence includes high-frequency terms, low-frequency terms, residual terms and original prices.

Optionally, the S3 includes:

extracting the data features of the reconstructed sequence from the reconstructed sequence by adopting the one-dimensional CNN.

Optionally, the self-attention mechanism is introduced into the BiSeq2seq model.

On the other hand, in order to achieve the above technical purpose, the application also provides a system for forecasting an agricultural product price based on signal decomposition and deep learning, including a decomposition module, a reconstruction module, an extraction module and a construction module;

the decomposition module is used for obtaining the price subsequences by performing the CEEMD on the original price sequence of the agricultural products;

the reconstruction module is used for obtaining the reconstructed sequence based on the price subsequences;

the extraction module is used for obtaining the data features of the reconstructed sequence based on the reconstructed sequence; and

the construction module is used for constructing the BiSeq2seq model, and inputting the data features of the reconstructed sequence into the CCS-BiSeq2seq model to obtain the forecasting result.

Optionally, the reconstruction module analyzes the Pearson correlation coefficients and the price subsequences, and reconstructs to obtain the reconstructed sequence, where the reconstructed sequence includes the high-frequency terms, the low-frequency terms, the residual terms and the original prices.

Optionally, the extraction module extracts the data features of the reconstructed sequence from the reconstructed sequence by adopting the one-dimensional CNN.

Optionally, the self-attention mechanism is introduced into the BiSeq2seq model.

The application has following technical effects.

Firstly, the application obviously reduces a forecast error through the CEEMD; and it is of great significance to ensure a balance of supply and demand and improve an early warning system of major events to prevent a price fluctuation of the agricultural products.

Secondly, the application learns information relationships between forward and backward data through the BiSeq2seq model, significantly improves a forecast effect, and not only avoids a damage of a whole connection layer to a time sequence relationship, but also realizes a multi-step forecasting from any input step to any output step.

Thirdly, the invention continuously reduces the forecast error through the one-dimensional CNN, introduces the self-attention mechanism, and improves the forecast accuracy.

Fourthly, the application greatly improves the forecast accuracy through five steps of decomposition, reconstruction, extraction, correlation and output, keeps values of evaluation indexes of mean absolute error (MAE) and mean absolute percentage error (MAPE) in a small range, and also has the good forecast accuracy on other agricultural product data sets; meanwhile, the application provides an idea of an interdisciplinary integration for solving a forecasting problem of the agricultural products.

### BRIEF DESCRIPTION OF THE DRAWINGS

In order to more clearly explain embodiments of the application or technical solutions in the prior art, the following briefly introduces drawings to be used in the embodiments. Obviously, the drawings in the following description are only some embodiments of the application. For those of ordinary skill in the art, other drawings may be obtained according to these drawings without any creative labor.

FIG. 1 is a flowchart of a method for forecasting an agricultural product price based on signal decomposition and deep learning in embodiment 1 of the application.

FIG. 2 is a schematic diagram of a CCS-Bi-directional Sequence to Sequence (CCS-BiSeq2seq) model in embodiment 1 of the application.

FIG. 3 is an operation flow chart of a one-dimensional convolutional neural network (CNN) in embodiment 1 of the application.

FIG. 4 is a schematic diagram of a Bi-directional long short term memory (Bi-LSTM) network structure in embodiment 1 of the application.

FIG. 5 is a schematic diagram of a Bi-directional Sequence to Sequence (BiSeq2seq) model in embodiment 1 of the application.

FIG. 6 is a schematic diagram of complementary ensemble empirical mode decomposition (CEEMD) results of a preferred embodiment in embodiment 1 of the application.

FIG. 7 is a reconstructed sequence diagram of a preferred embodiment in embodiment 1 of the application.

FIG. 8 is a forecasting result curve of a preferred embodiment in embodiment 1 of the application.

FIG. 9 is a price trend diagram of different agricultural products in a preferred embodiment in embodiment 1 of the application.

### DETAILED DESCRIPTION OF THE EMBODIMENTS

Technical solutions in embodiments of the application are clearly and completely described below with reference to drawings in the embodiments of the application. Obviously, the described embodiments are only a part of the embodiments of the application, but not all of them. Based on the embodiments of the application, all other embodiments obtained by ordinary technicians in the field without a creative labor are within a scope of the application.

### Embodiment 1

Experimental data of this embodiment comes from the National Agricultural Products Business Information Public Service Platform (New Rural Business Network), and the website is http://nc.mofcom.gov.cn/jghq/index. This embodiment takes scalded and gutted pork from an agricultural products wholesale market in Fengtai District of Beijing on this website as an empirical object to study a price trend of the scalded and gutted pork. An empirical analysis is made based on average daily prices of the scalded and gutted pork in this market from Jan. 1, 2016 to Feb. 28, 2022. Missing values and the values with large deviations in the data are interpolated and filled according to average values of monthly prices. Finally, a total of 2245 pieces of data are obtained.

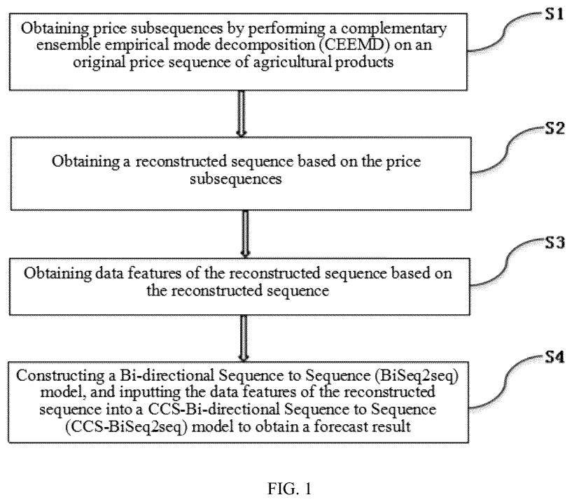

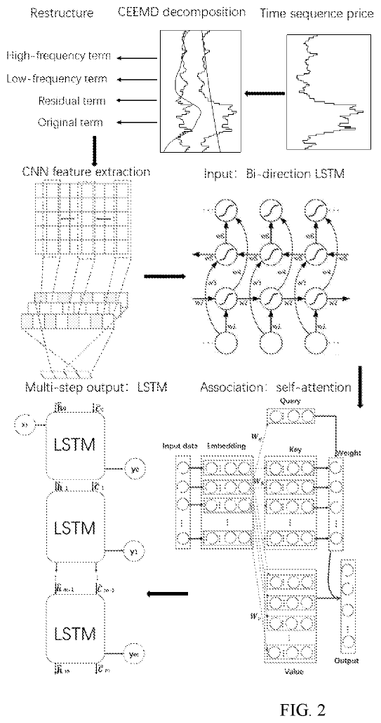

As shown in FIGS. 1-2, the application discloses a method for forecasting an agricultural product price based on signal decomposition and deep learning, including following steps.

S1: a complementary ensemble empirical mode decomposition (CEEMD) is performed on an original price sequence of the agricultural products to obtain price subsequences;

the CEEMD decomposes a complex signal into many simple signals, adds several pairs of white noise signals with opposite numbers to the signal to be decomposed, and decomposes a complex original price sequence signal into finite intrinsic mode functions (IMF) with different periods and a residual signal; the CEEMD has a good self-adaptation and effectively restrains a mode aliasing phenomenon in an empirical mode decomposition (EMD) method; meanwhile, a residual auxiliary noise in an ensemble empirical mode decomposition (EEMD) method is eliminated, a number of iterations required for the decomposition is reduced, false component information of the sequence signal is reduced, and a movement law and a movement structure in the complex signal are more clearly understood; a calculation process is as follows:

S11, adding a pair of positive and negative white noise signals nᵢ⁺(t) and nᵢ⁻(t) to an original price sequence signal O(t), obtaining a new set of sequence signals, and denoting as Oᵢ⁺(t) and Oᵢ⁻(t):

$$\{ \begin{matrix}{O}_{i}^{+} ( t ) = O ( t ) + {O}_{i}^{+} ( t ) \\ {O}_{i}^{-} ( t ) = O ( t ) + {O}_{i}^{-} ( t )\end{matrix} ;$$

S12, respectively performing an empirical mode decomposition (EMD) decomposition on Oᵢ⁺(t) and Oᵢ⁻(t) to obtain different price subsequences (IMF sequences) and residual terms; and the S12 specifically including:

S121, determining a maximum and a minimum of the original price sequence signal O(t), respectively determining an upper envelope and a lower envelope of Oᵢ⁺(t) and Oᵢ⁻(t) by a cubic spline interpolation, and then calculating average values m(t) of the upper envelope and the lower envelope, and calculating differences between the sequence signals Oᵢ⁺(t) and Oᵢ⁻(t) and m(t) respectively, and recording the differences as s(t):

$$\{ \begin{matrix}{s}_{i}^{+} ( t ) = {O}_{i}^{+} ( t ) - m ( t ) \\ {s}_{i}^{-} ( t ) = {O}_{i}^{-} ( t ) - m ( t )\end{matrix} ;$$

S122, if the obtained s(t) meets two conditions: first, in a sequence signal interval, a number of zero-crossing points is equal to or different from the number of extreme points by 1; second, the average values of the envelope of a local maximum and the envelope of a local minimum are zero at any time, defining s(t) as an ith IMF sequence; similarly, defining the residual component r(t) as a difference between O(t) and s(t) after the decomposition;

S123, repeating S122, adding different white noise signals each time, until it is impossible to screen out new IMF sequences from the sequence O(t); obtaining k sets of IMF sequences cₖᵢ⁺ and cₖᵢ⁻ and a set of residual terms rₖ⁺ and rₖ⁻, where cₖᵢ(t) is the kth IMF sequence generated by adding the white noise signal for the first time; finally obtaining:

$$\{ \begin{matrix}{O}_{i}^{+} ( t ) = {\sum }_{i = 1}^{k} {c}_{ki}^{+} ( t ) + {r}_{k}^{+} ( t ) \\ {O}_{i}^{-} ( t ) = {\sum }_{i = 1}^{k} {c}_{ki}^{-} ( t ) + {r}_{k}^{-} ( t )\end{matrix} ;$$

and

S124, averaging and then summing the final Oᵢ⁺(t) and Oᵢ⁻(t) sequences to obtain k IMF sequences and a residual term decomposed by the CEEMD:

$$\{ \begin{matrix}{C}_{i} ( t ) = \frac{1}{2 k} {\sum }_{i = 1}^{k} ( {C}_{ki}^{+} + {C}_{ki}^{-} ) \\ {r}_{k} ( t ) = \frac{1}{2 k} {\sum }_{i = 1}^{k} ( {r}_{k}^{+} + {r}_{k}^{-} )\end{matrix} .$$

A forecast error is significantly reduced through the CEEMD. It is of great significance to ensure a balance of supply and demand and improve an early warning system of major events to prevent a price fluctuation of agricultural products.

S2: Pearson correlation coefficients and the price subsequences are analyzed, and a reconstructed sequence is obtained by reconstructing, where the reconstructed sequence includes high-frequency terms, low-frequency terms, the residual terms and original prices.

A high-low frequency reconstruction is carried out through the Pearson correlation coefficients and the price subsequences (an IMF sequence diagram obtained in the Si); the high-frequency terms are superimposed, the low-frequency terms are superimposed, and the residual terms remain unchanged. The Pearson correlation coefficients are calculated as follows:

$${ρ}_{X , Y} = \frac{\sum ( X - \overline{X} ) ( Y - \overline{Y} )}{\sqrt{\sum {( X - \overline{X} )}^{2} ( \sum {( Y - \overline{Y} )}^{2} )}} ,$$

where X is any IMF sequence data after the decomposition; Y is the IMF sequence data which is different from X after the decomposition; X̅ is the average value of X; Y̅ is the average value of Y.

The noise in the original price sequence data is removed, the irregular and complex original price sequence data is transformed into simple price subsequences, and the high-frequency terms, the low-frequency terms and the residual terms are obtained through the CEEMD and the high-low frequency reconstruction.

S3: data features of the reconstructed sequence are obtained based on the reconstructed sequence;

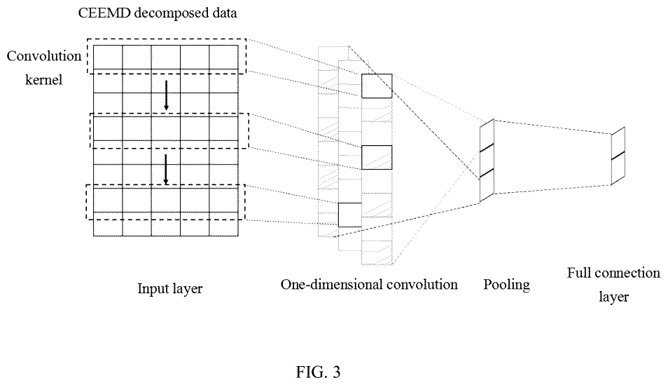

as shown in FIG. 3, a convolution kernel of a one-dimensional convolutional neural network (CNN) only slides in a one-way dimension, and acts on input data in sequence. The convolution kernel and the input data get a new eigenvector through a quantitative product. In a convolution process, a number of channels is increased, data variables are mapped to a high-dimensional space, and the data features are fitted in different dimensions, so an integrity of time sequence data is completely kept in time sequence and space, and a forecast error is continuously reduced. The reconstructed high-frequency terms, the low-frequency terms, the residual terms and the original data are transmitted into the one-dimensional CNN to extract a dependence between time sequence characteristics and the data, and the data features of the reconstructed sequence are obtained and transmitted into a Bi-directional Sequence to Sequence (BiSeq2seq) model as input terms. The calculation formula of the one-dimensional CNN is as follows:

C_{i,j}=wᵢ*xᵢ+bᵢ;

where * is a dot product, a numerical value C_{t,i} obtained after a multiplication; wᵢ is the convolution kernel of different channels and bᵢ is a offset term, and a convolution dimension is set according to a data input dimension.

S4: the BiSeq2seq model is constructed, and the data features of the reconstructed sequence are input into a CCS-Bi-directional Sequence to Sequence (CCS-BiSeq2seq) model to obtain a forecasting result;

### Sequence to Sequence (Seq2seq) Model

The Seq2seq model may realize an output of any number of steps in a time sequence forecasting problem, while keeping a sequence dependence between the input data. The Seq2seq model consists of an encoder and a decoder. The encoder and the decoder are essentially composed of a recurrent neural network (RNN) network, a long short-term memory (LSTM) network or other improved networks. The encoder compresses the input sequence into a state vector with a fixed length, and then the decoder transforms the state vector into an output sequence with a specified length, thus realizing a mapping of an input sequence of any length to an output sequence of any length.

### Long Short-Term Memory (LSTM) Network

The LSTM forgets insignificant data and learns useful data as much as possible through a design of gate structures and memory cells, thus alleviating problems of information forgetting, a gradient explosion and a gradient disappearance caused by too long input sequence data, and enables key information in the sequence to be updated and transmitted effectively.

Structures of the LSTM network are mainly composed of four parts: a forgetting gate, an input gate, a memory cell state and an output gate. The three gate structures are used to control the memory cell state to transmit information. A cell state updating process is similar to a conveyor belt, running in an uppermost chain, with a small amount of linear interaction in the whole process.

### Bi-Directional Long Short Term Memory (Bi-LSTM)

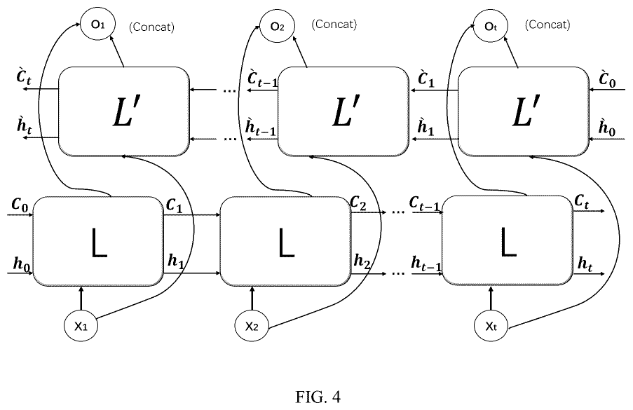

As shown in FIG. 4, the Bi-LSTM network is composed of two LSTM networks in forward and reverse directions; L and \grave{L} are LSTM network units, Cₜ and hₜ represent the parameters of the forward LSTM, and \grave{C}ₜ and \grave{h}ₜ represent the parameters of the reverse LSTM; and the output layer Oₜ splices the forward and reverse output vectors. A mathematical expression of the Bi-LSTM is as follows:

\vec{h}ₜ=LSTM (Xₜ, hₜ₋₁)

[symbol]

=LSTM(Xᵢ, hₜ₋₁)

Oᵢ=Concat(\vec{h}ₜ, [symbol] )′

where \vec{h}ₜ is an output state of the forward LSTM network at moment t; Xₜ is the input value at the moment t; hₜ₋₁ is the output state of the forward LSTM network at moment t−1; [symbol] is the output state of the reverse LSTM network at moment t; h′ₜ₋₁ is the output state of the reverse LSTM network at moment t−1;

### BiSeq2seq Model

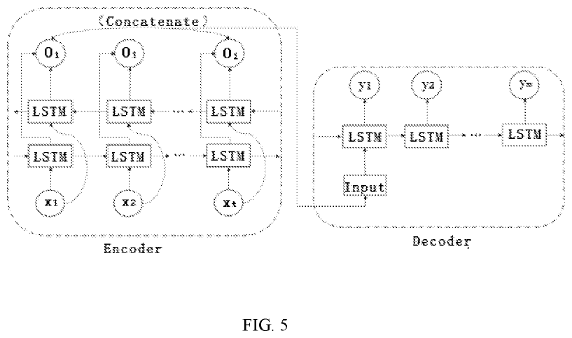

In this application, the LSTM network and the Seq2seq model are improved, and the BiSeq2seq model is proposed. As shown in FIG. 5, the BiSeq2seq model includes the encoder and the decoder; the encoder reads data by using the Bi-LSTM network, learns correlation information between positive and negative price sequence data with a high quality, and reduces data information forgetting; the decoder outputs by using the LSTM network to forecast the value of any number of steps in the future, so that the input sequence with any length may be mapped to the output sequence with any length, and the dependence between the sequences is kept; and the decoder may realize the output of any number of steps, and keep the dependence between the sequence data.

According to the application, a self-attention mechanism is introduced into the BiSeq2seq model, and the self-attention mechanism no longer needs the output value of the encoder to calculate an attention weight of each part, so that the dependence on external information is greatly reduced, a global correlation weight is efficiently calculated, and an internal correlation of sequence data features is captured; moreover, model parameters are reduced, a memory occupation is reduced, and a forecast accuracy is improved. Firstly, the input data is word embedded, and then multiplied by three parameter matrices W_{q}, Wₖ and Wᵥ respectively, to obtain three new matrix vectors of Query, Value and Key related to the task; a dot product operation is made between Query and Key, and correlation weights are generated among data by an activate function softmax; and each correlation weight is multiplied by Value and then summed, and finally a representation vector after the operation of the self-attention mechanism is obtained. The application does not need an Embedding process, and the calculation process is as follows.

(1) Three matrices, Query, Key and Value are calculated, and W_{q}, Wₖ, Wᵥ, are obtained through a training, where Query, Key and Value are results of different linear transformations of the input data and are multiplied by W_{q}, Wₖ and Wᵥ respectively. Query is a query vector, Key is the other input vector after the linear transformation, and Value is an actual vector after the linear transformation. W_{q}, Wₖ and Wᵥ are the required parameter vectors, and may be obtained through a deep learning training.

Q=X×W_{q}

K=X×Wₖ

V=X×Wᵥ

(2) Attention is calculated, and divided by \sqrt{dₖ} for a stability of a gradient back

propagation, where dₖ represents the dimension of a column vector in data:

$$Attention ( Q , K , V ) = softmax ( \frac{Q {K}^{T}}{\sqrt{{d}_{k}}} ) {V}^{T} .$$

According to the application, the self-attention mechanism is introduced into the encoder of the BiSeq2seq model, so that a global relevance between the input sequences is strengthened, and the forecast accuracy is further improved.

The CCS-BiSeq2seq model is completed, and the data features of the reconstructed sequence are input into the CCS-BiSeq2seq model to obtain forecasting results.

### Preferred Embodiment

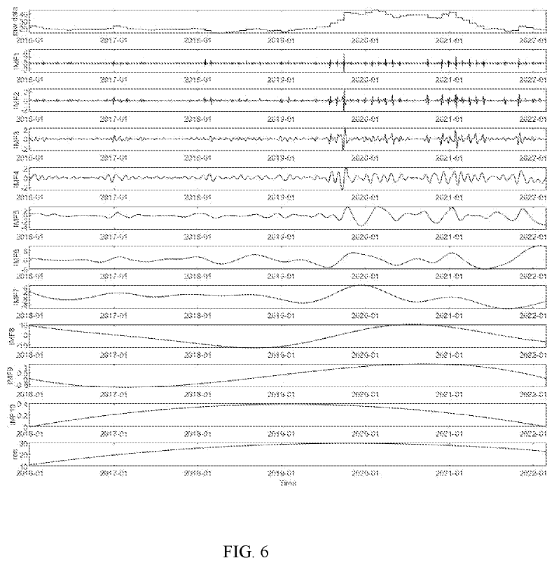

(I) Firstly, a daily price of the scalded and gutted pork is decomposed by the CEEMD to obtain multi-scale characteristics of the data. The white noise amplitude is set to 0.2 (0-1, the best effect is 0.2), and an average number of signal accumulations is 50 (in this experiment, when the value is 50, the IMF sequences are the most, and the subsequences solved when the value is less than 50 also have a good effect). After decomposing the original price sequence data of the agricultural products, 10 IMF subsequences and 1 residual term are obtained, as shown in FIG. 6. As may be seen from FIG. 6, an amplitude, a frequency and a period of each decomposed IMF sequence (price subsequence) are different, and all have their own fluctuation characteristics. From the analysis, it may be seen that the periods of the decomposed IMF sequences increase from top to bottom, each sequence data changes from basic symmetry to asymmetry, a mean value of the data keeps deviating from 0, and the residual term shows an approximately linear upward trend. At the 7th IMF sequence, the sequence diagram begins to become asymmetric.

(II) The Pearson correlation coefficients are calculated among the IMF sequences, as shown in Table 1. At the 7th IMF sequence, the Pearson correlation coefficient begins to change significantly, and the data obviously deviates from 0. Therefore, IMF1-IMF6 are designated as the high-frequency terms, and IMF7-IMF10 are designated as the low-frequency terms.

TABLE 1

| | Sequence | Sequence | Sequence | Sequence | Sequence |
|---|---|---|---|---|---|
| IMF sequence | 1 | 2 | 3 | 4 | 5 |
| Pearson correlation | 0.026196 | 0.041991 | 0.072803 | 0.065748 | 0.18935 |
| coefficient | | | | | |
| | Sequence | Sequence | Sequence | Sequence | Sequence |
| | 6 | 7 | 8 | 9 | 10 |
| Pearson correlation | 0.19765 | 0.47455 | 0.85071 | 0.71305 | −0.16863 |
| coefficient | | | | | |

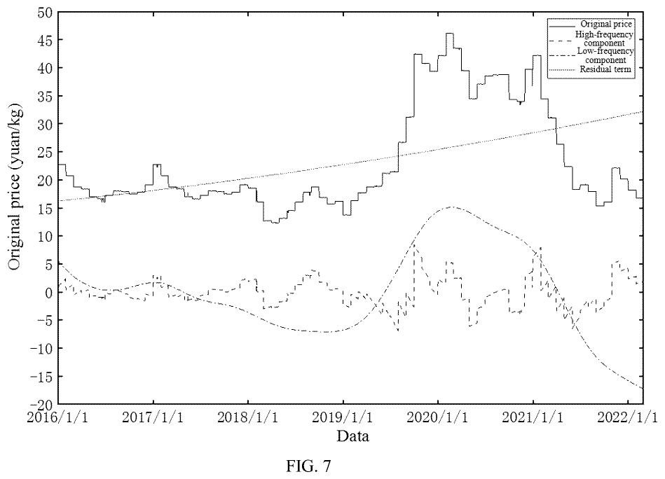

(III) The original price sequence of the agricultural products is reconstructed, the values of the high-frequency terms IMF1-IMF6 are superposed and the values of the low-frequency terms IMF7-IMF10 are superposed, and the residual term is kept unchanged, and a reconstructed price sequence diagram is obtained as shown in FIG. 7. As may be seen from FIG. 7, the residual term is a main component that affects the price of the scalded and gutted pork, reflects an inherent long-term trend of the price of the scalded and gutted pork, and is mainly determined by the relationship between supply and demand; the trend of the high-frequency terms is similar to that of the original data, and the average values of the IMF sequences fluctuate around 0, so the high-frequency terms have little impact on the overall trend, and represent short-term fluctuations caused by conventional economic policy reforms, futures speculations, short-term imbalances between market supply and demand, and changes in related foreign markets; and a fluctuation range of the low-frequency terms is large, so the low-frequency terms have a great impact on the trend of original data, and represent the impact of major events on the price of scalded and gutted pork. After consulting, peaks and valleys basically correspond to the major events, such as African swine fever in 2019, a promulgation of standardized breeding policy, an outbreak of COVID-19 epidemic in 2020, etc.

(IV) Agricultural product price forecast based on the CCS-BiSeq2seq model

(1) Data set division

As a data standardization operation needs be completed on training set data, if the test set data is included, a data leakage may occur, resulting in an inaccurate forecasting, so the data set is divided first. The first 90% of the reconstructed white-skinned pork price data is set as the training set, and the remaining 10% is set as the test set.

Due to a lag of the forecasting of time sequence problems, in order to better determine a number of forecasting steps of the decoder LSTM network, this preferred embodiment designs different lag days, and the lag days are [3,5,7,9,11,13,15]. In this preferred embodiment, the lag days are 11 days for the forecasting.

(2) Data preprocessing

The four features of the high-frequency term, the low-frequency term, the residual term and the original data price after the CEEMD are set as input features to forecast the short-term price of the scalded and gutted pork. Firstly, the data is serialized and sorted according to the date from small to large; in order to avoid abnormal data and more noise for a grouping standardization, a standard score Z-Score is adopted here for processing, and the calculation formula is as follows:

$$x = \frac{{x}_{i} - {x}_{min}}{{x}_{max} - {x}_{min}} ,$$

where x is a normalized value; x i is the i th value in the data; x miii is the minimum in the data; x max is the maximum in the data;

(3) Parameter setting

A specific network structure and the parameters are shown in Table 2.

TABLE 2

| Number of | | Data | Dimension |
|---|---|---|---|
| layers | Structure | dimension | setting |
| First layer | Input layer | 3d | (−1, 2028, 4) |
| Second layer | One-dimensional | 3d | (−1, 2028, 32) |
| | CNN layer | | |
| Third layer | Dropout layer | 3d | (−1, 2028, 32) |
| Fourth layer | Encoder Bi-LSTM | 3d | (−1, 2028, 256) |
| | network | | |
| Fifth layer | Self-attention | 3d | (−1, 2028, 256) |
| | mechanism layer | | |
| Sixth layer | Global average | 2d | (−1, 256) |
| | pooling layer | | |
| Seventh layer | Repeat Vector layer | 3d | (−1, 224, 256) |
| Eighth layer | Decoder LSTM network | 3d | (−1, 224, 128) |
| Ninth layer | Output layer | 3d | (−1, 224, 1) |

The network consists of nine layers: the first layer is the input layer for transforming the reconstructed data decomposed by the CEEMD into three-dimensional vectors; the second layer is the one-dimensional CNN convolution layer for extracting the reconstructed data features; the third layer is a Dropout layer, with a Dropout value of 0.2, so as to prevent an over-fitting and randomly ignore 20% of node connections in a training process; the fourth layer takes the extracted data features as input data and transmits the extracted data features to the Bi-LSTM network in the encoder to learn a nonlinear relationship between a forecasted price and other input features; the fifth layer adds the self-attention mechanism after the encoder to capture global information and an influence degree between different stages of data; the sixth layer uses global average pooling after the self-attention mechanism to reduce training parameters and increase a training speed; the seventh layer, Repeat Vector layer, replicates the output vector of the decoder to form a vector with time steps; the eighth layer forecasts by the LSTM network in the decoder; and the ninth layer, uses Time Distributed as a output layer, prevents a time dimension and sequence information from being decomposed, makes a full connection forecasting for each value separately, and then outputs the results.

Mean square error (MSE) is used as a loss function for a forward propagation of the model, and Adam optimization algorithm is used to update weight parameters and biases by a backward propagation. A training batch size is 256, a training period is 200 and a learning rate is 0.001. Meanwhile, a mean absolute error (MAE) and a mean absolute percentage error (MAPE) are used as metrics. The calculation formula of each metric is as follows:

$$M S E = \frac{1}{n} {\sum }_{i = 1}^{n} {( {y}_{i} - {\hat{y}}_{i} )}^{2}$$

$$M A E = \frac{1}{n} {\sum }_{i = 1}^{n} \vert {y}_{i} - {\hat{y}}_{i} \vert$$

$$M A P E = \frac{1}{n} {\sum }_{i = 1}^{n} \vert \frac{{y}_{i} - {\hat{y}}_{i}}{{y}_{i}} \vert \times 100 \% .$$

At the same time, benchmark models are set for comparative experiments, and forecast error results of each model are shown in Table 3. For convenience of description, Self-attention is referred to as Sa for short in subsequent charts:

TABLE 3

| Model structure | MSE | MAE | MAPE |
|---|---|---|---|
| LSTM | 2.9107 | 1.2142 | 5.8706 |
| Seq2seq | 2.2716 | 0.8799 | 4.1782 |
| CEEMD-Seq2seq | 2.1055 | 1.1151 | 5.9913 |
| CEEMD-BiSeq2seq | 1.8340 | 1.0397 | 5.6436 |
| CEEMD-CNN-LSTM | 1.6781 | 0.7341 | 3.5259 |
| CEEMD-CNN-Seq2seq | 1.3676 | 0.8139 | 3.2501 |
| CEEMD-CNN-BiSeq2seq | 1.0606 | 0.8707 | 2.9975 |
| CEEMD-CNN-LSTM-Sa | 0.4868 | 0.5160 | 2.6337 |
| CEEMD-CNN-Seq2seq-Sa | 0.2727 | 0.4693 | 2.5543 |
| CCS-BiSeq2seq | 0.1080 | 0.2796 | 1.4547 |

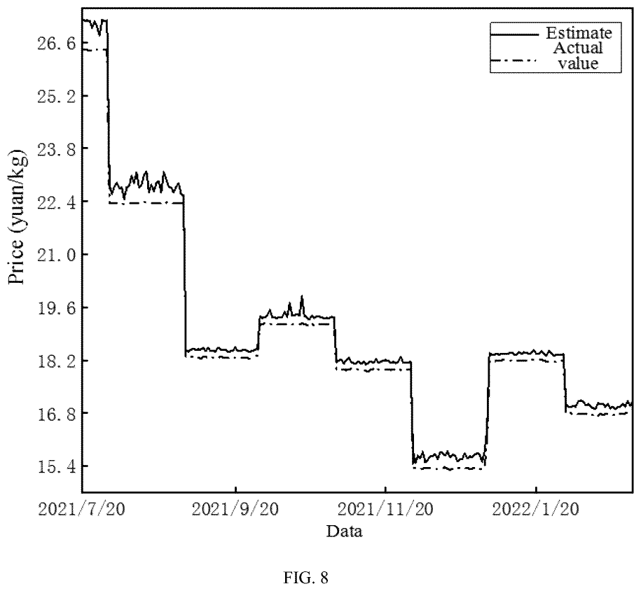

It may be seen from Table 3 that the forecast error of the CCS-BiSeq2seq model is obviously lower than that of other models, and the forecast accuracy of the CCS-BiSeq2seq model is better than that of the benchmark models, where the loss value, Loss, is 0.1080, the MAE value is 0.2796, and the MAPE value is 1.4547, so the forecast error is very small, and forecasting data basically accords with original data. Comparing the output value of the CCS-BiSeq2seq model with the original data, it may be seen that this model accurately forecasts the prices of the scalded and gutted pork in the next seven months (July 2021 to February 2022), and a forecast trend chart basically fits the original data, as shown in FIG. 8.

To further highlight a forecast effect of the CCS-BiSeq2seq model, the forecast effects of the LSTM, CNN-LSTM, Seq2seq and CEEMD-CNN-Seq2seq models are compared in turn, and all evaluation indexes, training batches, the training parameters and the training periods are consistent. Therefore, the forecast accuracy of the CCS-BiSeq2seq model according to the application is more consistent with the original data.

(4) Lag days;

The forecasting of the time sequence problem usually leads to a lag. The forecasting of the next few days maps the data features of the previous few days. In order to verify the value of the lag days of the CCS-BiSeq2seq model when the price forecasting effect is the best, forecasting experiments with different lag days are set, and other parameters are consistent with the above settings of this preferred embodiment. The experimental results are shown in Table 4.

TABLE 4

| Lag days | MSE | MAE | MAPE |
|---|---|---|---|
| 3 | 1.3737 | 1.0741 | 5.7266 |
| 5 | 0.9226 | 0.8412 | 4.4336 |
| 7 | 0.6322 | 0.6473 | 3.3777 |
| 9 | 0.4732 | 0.5143 | 2.6795 |
| 11 | 0.1797 | 0.3689 | 2.0548 |
| 13 | 0.3345 | 0.4904 | 2.7756 |
| 15 | 0.5365 | 0.6177 | 3.5032 |

It may be seen from Table 4 that when the lag days are 9-13 days, a forecast error range is small, and when the lag days are 11 days, the forecast accuracy is the best, and the MAE and MAPE values are the lowest. When the lag days are 5 days, the forecast error begins to decrease, and when the lag days are 11 days, the forecast error reaches the minimum, and then the forecast error begins to increase again. The results show that the CCS-BiSeq2seq model may be better used for a short-term price forecasting.

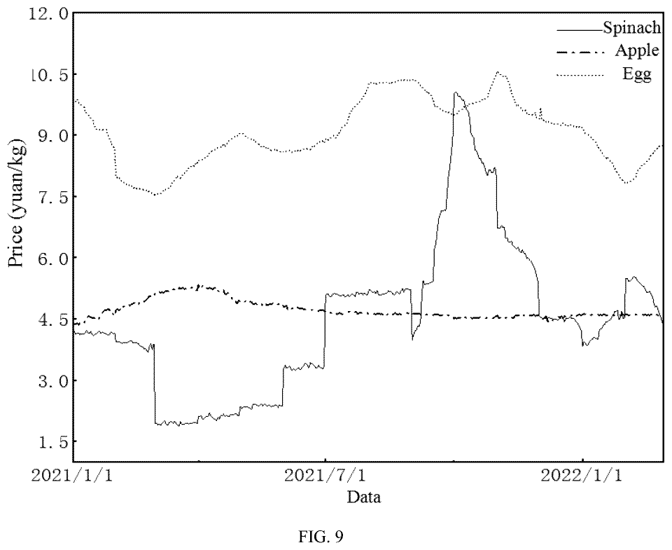

In order to verify the accuracy of the CCS-BiSeq2seq model forecasting on other agricultural products data sets, the price data of three kinds of common agricultural products of spinach, apple and egg from Jan. 1, 2021 to Feb. 28, 2022 are selected for the forecasting. The data is shown in FIG. 9. The data set division, the training parameters, and the lag days, etc. are the same as those in this preferred embodiment, and the forecast errors of different agricultural product prices obtained by the experiments are shown in Table 5.

TABLE 5

| Agricultural | | | |
|---|---|---|---|
| product | MSE | MAE | MAPE |
| Spinach | 0.2328 | 0.4080 | 7.8067 |
| Apple | 0.1597 | 0.1854 | 4.0317 |
| Egg | 0.1725 | 0.3378 | 4.1862 |

It may be seen from Table 5 that the MSE values of the three kinds of agricultural products are all less than 0.3, so the CCS-BiSeq2seq model also has a good accuracy in the price forecasting of different kinds of agricultural products, and the forecast error is still very low when a data amount is small.

### Embodiment 2

The application also discloses a system for forecasting an agricultural product price based on signal decomposition and deep learning, including a decomposition module, a reconstruction module, an extraction module and a construction module;

the decomposition module is used for obtaining the price subsequences by performing the CEEMD on the original price sequence of the agricultural products;

the reconstruction analyzes the Pearson correlation coefficients and the price subsequences, and reconstructs to obtain the reconstructed sequence, where the reconstructed sequence includes the high-frequency terms, the low-frequency terms, the residual terms and the original prices;

the extraction module extracts the data features of the reconstructed sequence from the reconstructed sequence by adopting the one-dimensional CNN; and

the construction module is used for constructing the BiSeq2seq model, and inputting the data features of the reconstructed sequence into the CCS-BiSeq2seq model to obtain the forecasting result.

The above shows and describes a basic principle, main features and advantages of the application. It should be understood by those skilled in the art that the application is not limited by the above-mentioned embodiments. The above-mentioned embodiments and descriptions only illustrate the principles of the application. Without departing from a spirit and a scope of the application, there are various changes and improvements of the application, all of which fall within the scope of the claimed application. The scope of the application is defined by the appended claim and their equivalents.

What is claimed is:

1. A method for forecasting an agricultural product price based on signal decomposition and deep learning, comprising:
S1, obtaining price subsequences by performing a complementary ensemble empirical mode decomposition (CEEMD) on an original price sequence of agricultural products;
S2, obtaining a reconstructed sequence based on the price subsequences;
S3, obtaining data features of the reconstructed sequence based on the reconstructed sequence; and
S4, constructing a Bi-directional Sequence to Sequence (BiSeq2seq) model, and inputting the data features of the reconstructed sequence into a CCS-Bi-directional Sequence to Sequence (CCS-BiSeq2seq) model to obtain a forecasting result.

2. The method for forecasting the agricultural product price based on the signal decomposition and the deep learning according to claim 1, wherein the S2 comprises:
analyzing the Pearson correlation coefficients and the price subsequences, and reconstructing to obtain the reconstructed sequence, wherein the reconstructed sequence comprises high-frequency terms, low-frequency terms, residual terms and original prices.

3. The method for forecasting the agricultural product price based on the signal decomposition and the deep learning according to claim 1, wherein the S3 comprises:
extracting the data features of the reconstructed sequence from the reconstructed sequence by adopting a one-dimensional convolutional neural network (CNN).

4. The method for forecasting the agricultural product price based on the signal decomposition and the deep learning according to claim 1, wherein a self-attention mechanism is introduced into the BiSeq2seq model.

5. A system for forecasting an agricultural product price based on signal decomposition and deep learning, comprising a decomposition module, a reconstruction module, an extraction module and a construction module;
the decomposition module is used for obtaining price subsequences by performing a complementary ensemble empirical mode decomposition (CEEMD) on an original price sequence of agricultural products;
the reconstruction module is used for obtaining a reconstructed sequence based on the price subsequences;
the extraction module is used for obtaining data features of the reconstructed sequence based on the reconstructed sequence; and
the construction module is used for constructing a Bi-directional Sequence to Sequence (BiSeq2seq) model, and inputting the data features of the reconstructed sequence into a CCS-Bi-directional Sequence to Sequence (CCS-BiSeq2seq) model to obtain a forecasting result.

6. The system for forecasting the agricultural product price based on the signal decomposition and the deep learning according to claim 5, wherein the reconstruction module analyzes Pearson correlation coefficients and the price subsequences, and reconstructs to obtain the reconstructed sequence, wherein the reconstructed sequence comprises high-frequency terms, low-frequency terms, residual terms and original prices.

7. The system for forecasting the agricultural product price based on the signal decomposition and the deep learning according to claim 5, wherein the extraction module extracts the data features of the reconstructed sequence from the reconstructed sequence by adopting a one-dimensional convolutional neural network (CNN).

8. The system for forecasting the agricultural product price based on the signal decomposition and the deep learning according to claim 5, wherein a self-attention mechanism is introduced into the BiSeq2seq model.
